(19) United States
(12) Patent Application Publication
(10) Pub. No.: US 2025/0105992 A1
(43) Pub. Date: Mar. 27, 2025

(54) Radio Network Node, User Equipment and Methods Performed Therein

(71) Applicant: Telefonaktiebolaget LM Ericsson (publ), Stockholm (SE)

(72) Inventors: Muhammad Ali Kazmi, Sundbyberg (SE); Santhan Thangarasa, Vällingby (SE); Andreas Höglund, Solna (SE); Emre Yavuz, Stockholm (SE); Kazuyoshi Uesaka, Kawasaki, Kanagawa (JP); Zhixun Tang, Beijing (CN)

(21) Appl. No.: 18/725,996

(22) PCT Filed: Dec. 27, 2022
(86) PCT No.: PCT/SE2022/051244

§ 371 Date: Jul. 1, 2024

(30) Foreign Application Priority Data
Jan. 10, 2022 (WO) PCT/CN2022/071047

(51) Int. Cl. H04L 5/14; H04W 36/04

(52) U.S. Cl. CPC H04L 5/14; H04W 36/04

(57) ABSTRACT

It is herein disclosed a method performed by a radio network node (13) for handling communication in a wireless communications network. The radio network node transmits an indication indicating duplex barring information (DBI) associated with or related to at least one duplex operational mode (DOM) of a UE (10), wherein the DBI for a cell indicates whether the UE (10) supporting the at least one DOM can access the cell, or not.

### TECHNICAL FIELD

Embodiments herein relate to a radio network node, a user equipment (UE) and methods performed therein regarding wireless communication. Furthermore, a computer program and a computer readable storage medium are also provided herein. In particular, embodiments herein relate to handling cell barring in a wireless communications network.

### BACKGROUND

In a typical wireless communications network, UEs, also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node e.g. a Wi-Fi access point or a radio base station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate, e.g., enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and coming 3GPP releases, such as New Radio (NR), are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the RAN of an EPS has an essentially “flat” architecture comprising radio network nodes connected directly to one or more core networks.

With the emerging 5G technologies such as NR, the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

Procedures and requirements to support reduced capability (Redcap) UE, which entails characteristics like low complexity, low power consumption and low, are being specified in Rel-17. A RedCap UE will support the following UE complexity reduction features:
Reduced maximum UE bandwidth:
   Maximum bandwidth of frequency range one (FR1) RedCap UE during and after initial access is 20 MHz.
   Maximum bandwidth of frequency range two (FR2) RedCap UE during and after initial access is 100 MHz.
Reduced minimum number of receiver (Rx) branches:
   For frequency bands where a legacy NR UE is required to be equipped with a minimum of 2 Rx antenna ports, the minimum number of Rx branches supported by specification for a RedCap UE is 1. The specification also supports 2 Rx branches for a RedCap UE in these bands.
   For frequency bands where a legacy NR UE, other than 2-Rx vehicular UE, is required to be equipped with a minimum of 4 Rx antenna ports, the minimum number of Rx branches supported by specification for a RedCap UE is 1. The specification also supports 2 Rx branches for a RedCap UE in these bands.
Maximum number of DL multiple input multiple output (MIMO) layers:
   For a RedCap UE with 1 Rx branch, 1 DL MIMO layer is supported.
   For a RedCap UE with 2 Rx branches, 2 DL MIMO layers are supported.
Relaxed maximum modulation order:
   Support of 256 quadrature amplitude modulation (QAM) in DL is optional, instead of mandatory, for an FR1 RedCap UE.
   No other relaxations of maximum modulation order are specified for a RedCap UE.
Duplex operation: Frequency Division Duplex (FDD), half duplex (HD)-FDD and Time Division Duplex (TDD)

### Duplex Operational Capabilities.

A frequency band or an operating frequency band supports one or more certain duplex modes of operation or duplex operational mode. Examples of duplex modes are FDD, TDD, HD-FDD, full duplex (FD). A device, e.g., UE, base station (BS) etc, may be capable of any of the duplex modes for certain supported frequency band. A UE may explicitly indicate its duplex mode of operation for a band or implicitly if the supported band only supports one duplex mode, e.g., by signalling UE capability related to duplex mode and/or band to the network.
In FDD mode of operation, the transmission of signals by the device and reception of signals by the same device take place on different carrier frequency channels. Therefore, in FDD mode both transmission and reception of signals can occur simultaneously in time. For example, the time resources used for transmission of the signals and the time resources used for the reception of the signals may fully or partially overlap in time. The FDD operation may also be called as full duplex-FDD (FD-FDD).
In TDD mode of operation, the transmission of signals by the device and reception of signals by the same device take place on the same carrier frequency channel but in different time resources, which do not overlap in time.
In HD-FDD mode of operation, the transmission of signals by the device and reception of signals by the same device take place take place on different carrier frequencies as well as on different time resources, which do not overlap in time. This means the transmission and reception of the signals don't occur simultaneously in time. HD-FDD can be regarded as a hybrid duplex scheme combining properties of FDD and TDD. HD-FDD does not require duplex fillers reducing cost, processing and power consumption of the device, e.g., UE. The HD-FDD UE may also require one local oscillator to tune or change or switch between transmit, e.g., uplink, carrier frequency and receive, e.g., downlink, carrier frequency. It may be common that a base station (BS) operates in FDD while all UEs support HD-FDD in a cell or some UEs support HD-FDD and some UEs support FDD in the same cell.
In FD mode of operation, the transmission of signals by the device and reception of signals by the same device take place on the same carrier frequency as well as during the same time resource. This means the transmission and reception of the signals occur simultaneously in time and on the same carrier. FD operation requires mechanism to eliminate or reduce self-interference at the receiver caused by the transmitted signal from the same transceiver, which is relatively much stronger, e.g., 80-90 dB, compared to the received signal. FD operation also requires mechanism to eliminate or reduce the interference caused by other radio stations such as BS or UE, which is relative much stronger, e.g., 40-50 dB, compared the FDD or synchronized TDD operation. Isolation can be realized by means of one or more of, e.g., physical isolation, beamforming, interference mitigation, e.g., cancellation, etc.

In the above examples of the duplex modes the device can be a UE or a network node, e.g., BS:
In case of the UE, the transmission of signals and reception of signals may also be called as the UL transmission of the signals by the UE and DL reception of signals at the UE, respectively.
In case of a network node, e.g., BS, the transmission of signals and reception of signals may also be called as the DL transmission of the signals by the network node and UL reception of signals at the network node, respectively.
The term time resource may refer to any one or more of: symbol, slot, subslot, mini-slot, subframe, frame etc.

### Cell Barring Mechanism.

Access barring mechanism is used under certain circumstances or in certain scenarios to prevent a UE from access attempts, including emergency call attempts, or when responding to paging in some areas of a public land mobile network (PLMN). Broadcast messages are transmitted on cell by cell basis indicating the class(es) or categories of subscribers which are barred from accessing the network. There are two types of access barring: ‘cell barring’ and ‘access class barring’. Cell barring is intended to bar UEs from accessing the cell on a long-term basis and is common for all UEs. E.g., a carrier which is intended to be used for off-loading can be set as cell barred to ensure UEs does not directly attempt to access this carrier but instead use the “main carrier” for access. Cell barring information is transmitted in master information block (MIB) and is indicated by the information element (IE) cellBarred.

Access class barring is instead used upon congestion to reduce the number of incoming access attempts. UEs are configured with different access classes and the barring parameters configured in SIB1 allows for reducing the access attempts from the different access classes.

In order to camp on certain cell, the UE has to acquire at least the contents of the MIB and system information block one (SIB1) for that cell.

### SUMMARY

As part of developing embodiments herein a problem has been identified. For example, a Redcap UE may be capable of supporting different types of duplex operations, e.g., FDD, HD-FDD, TDD etc. The UE's duplex operational capability may also depend on frequency band, e.g., for a certain band the UE may support FDD while for another band the UE may support HD-FDD etc. A Redcap UE may support different types of receiver configuration, e.g., 1 receiver (Rx) or 2 Rx. A Redcap UE may support any combination of the duplex operational capability and receiver configuration.

Every base station may not be able to efficiently serve different Redcap UE capabilities. For example, a legacy BS operating on FDD carrier may not be upgraded or is not yet upgraded to serve HD-FDD capable UEs. Serving HD-FDD capable UEs in an FDD base station requires new scheduling paradigm to ensure that the UE does not drop important data/reference signals required by the UE and/or the BS for different procedures. Similarly serving UE capable of HD-FDD and supporting fewer receivers, e.g., 1Rx, may require the BS to adapt its maximum MIMO layers and/or transmission power and/or may have to handle more retransmissions. HD-FDD also requires network implementation changes for the scheduler and collision cases, for different physical (PHY)-channels.

In NR release (Rel)-18, FD operation is also being specified. A legacy network not supporting FD can serve FD capable UE also using a less efficient duplex mode, e.g., FDD or HD-FDD or even TDD. But this approach is not very efficient from UE perspective as the UE can operate more efficiently, e.g., with higher throughput and/or better spectral efficiency.

The BS may also have to serve mixture of UEs supporting different duplex operational capabilities. This requires implementation of different resource allocation mechanisms in the same BS. But this may not be very efficient or not supported by all the BSs.

Currently there is no mechanism to limit or avoid operation of UEs supporting different duplex operational capabilities in a certain BS, e.g., legacy BS or BS with limited resources.

Therefore, new procedures to efficiently handle UEs supporting different duplex operational capabilities are proposed herein.

An object herein is to provide a mechanism to handle communication in an efficient manner in the wireless communications network.

According to an aspect the object is achieved, according to embodiments herein, by providing a method performed by a radio network node, such as a BS, for handling communication in a wireless communications network. The radio network node transmits an indication indicating duplex barring information (DBI) associated with or related to at least one duplex operational mode (DOM) of a UE, wherein the DBI for a cell indicates whether the UE supporting the at least one DOM can access the cell, or not. The indication may be transmitted to the UE or another radio network node. For example, a first radio network node may receive, from a second radio network node, the indication indicating DBI associated with or related to at least one DOM of a UE, wherein the DBI for a cell indicates whether the UE supporting the at least one DOM can access the cell, or not.

According to another aspect the object is achieved, according to embodiments herein, by providing a method performed by a UE for handling communication in a wireless communications network. The UE obtains an indication indicating DBI associated with or related to at least one DOM of the UE, wherein the DBI for a cell indicates whether the UE supporting the at least one DOM can access the cell, or not. The indication may be received from a radio network node or retrieved internally. The UE uses the indication for determining whether the UE can access a cell and/or stores the indication.

According to an aspect the object is achieved, according to embodiments herein, by providing a radio network node, and a UE configured to perform the methods herein, respectively.

According to yet another aspect the object is achieved, according to embodiments herein, by providing a radio network node for handling communication in a wireless communications network. The radio network node is configured to transmit an indication indicating DBI associated with or related to at least one DOM of a UE, wherein the DBI for a cell indicates whether the UE supporting the at least one DOM can access the cell, or not. The indication may be transmitted to the UE or another radio network node.

According to still another aspect the object is achieved, according to embodiments herein, by providing a UE for handling communication in a wireless communications network. The UE is configured to obtain an indication indicating DBI associated with or related to at least one DOM of the UE, wherein the DBI for a cell indicates whether the UE supporting the at least one DOM can access the cell, or not. The indication may be received from a radio network node or retrieved internally. The UE is configured to use the indication for determining whether the UE can access a cell and/or to store the indication.

It is furthermore provided herein a computer program product comprising instructions, which, when executed on at least one processor, cause the at least one processor to carry out any of the methods herein, as performed by the radio network node and the UE, respectively. It is additionally provided herein a computer-readable storage medium, having stored thereon a computer program product comprising instructions which, when executed on at least one processor, cause the at least one processor to carry out any of the methods herein, as performed by the radio network node and the UE, respectively.

Embodiments herein disclose procedures for the UE and the radio network node to distribute the DBI in the wireless communications network. Thus, it is herein provided a mechanism that allows the network to bar or forbid access to a cell, e.g., served by a legacy radio network node, which does not support or cannot efficiently serve the UE capable of a certain type of duplex operation, e.g., legacy FDD cell may not support scheduling UE with HD-FDD operation. This enables or directs the UE to access another cell which can serve the UE more efficiently. Thus, it is herein disclosed a solution to handle communication in an efficient manner in the wireless communications network.

### BRIEF DESCRIPTION OF THE DRAWINGS

Embodiments will now be described in more detail in relation to the enclosed drawings, in which:

FIG. 1 shows an overview depicting a wireless communications network according to embodiments herein;

FIG. 2 shows a combined signalling scheme and flowchart depicting embodiments herein;

FIG. 3 shows a combined signalling scheme and flowchart depicting embodiments herein;

FIG. 4 shows an overview depicting a wireless communications network according to some embodiments herein;

FIG. 5 an overview depicting a wireless communications network according to some embodiments herein;

FIG. 6 shows a flowchart depicting a method performed by a radio network node according to embodiments herein;

FIG. 7 shows a flowchart depicting a method performed by a UE according to some embodiments herein;

FIGS. 8a and 8b show block diagrams depicting embodiments of a radio network node according to embodiments herein;

FIGS. 9a and 9b show block diagrams depicting embodiments of a UE according to embodiments herein;

FIG. 10 schematically illustrates a telecommunication network connected via an intermediate network to a host computer;

FIG. 11 is a generalized block diagram of a host computer communicating via a base station with a user equipment over a partially wireless connection; and

FIGS. 12,13,14,15 are flowcharts illustrating methods implemented in a communication system including a host computer, a base station and a user equipment.

### DETAILED DESCRIPTION

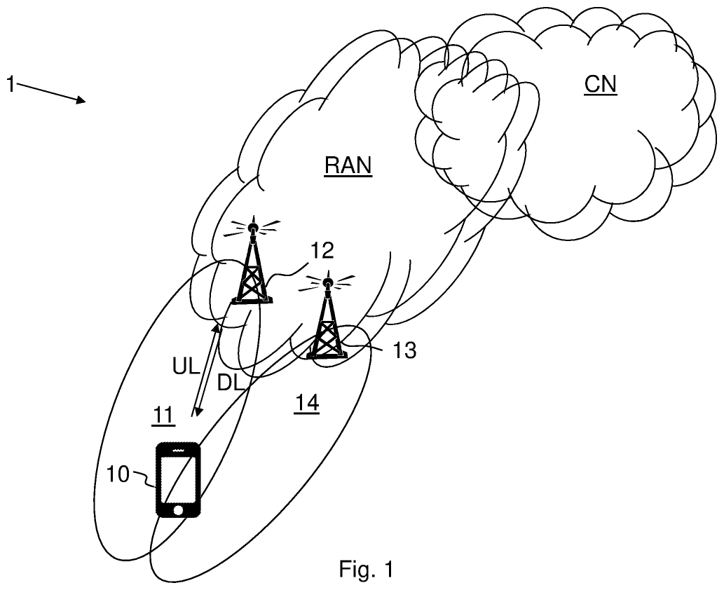

Embodiments herein relate to wireless communications networks in general. FIG. 1 is a schematic overview depicting a wireless communications network 1. The wireless communications network 1 comprises one or more RANs and one or more CNs. The wireless communications network 1 may use one or a number of different technologies. Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the wireless communications network 1, a user equipment (UE) 10 exemplified herein as a wireless device such as a mobile station, a non-access point (non-AP) station (STA), a STA and/or a wireless terminal, is comprised communicating via e.g. one or more Access Networks (AN), e.g. radio access network (RAN), to one or more core networks (CN). It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The wireless communications network 1 comprises a first radio network node 12 or just radio network node, providing radio coverage over a geographical area, a first service area 11 or first cell, of a first radio access technology (RAT), such as NR, LTE, or similar. The first radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node depending e.g. on the first radio access technology and terminology used. The first radio network node 12 may be referred to as a serving radio network node wherein the service area may be referred to as a serving cell, and the serving network node communicates with the UE 10 in form of DL transmissions to the UE 10 and UL transmissions from the UE 10. It should be noted that a service area may be denoted as cell, beam, beam group or similar to define an area of radio coverage.

The wireless communications network 1 comprises a second radio network node 13 or another radio network node, providing radio coverage over a geographical area, a second service area 14 or second cell, of a second RAT, such as NR, LTE, or similar. The second radio network node 13 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node depending e.g. on the first radio access technology and terminology used. The second radio network node 13 may be referred to as a target radio network node wherein the service area may be referred to as a target cell, and the target network node communicates with the UE 10 in form of DL transmissions to the UE 10 and UL transmissions from the UE 10. It should be noted that a service area may be denoted as cell, beam, beam group or similar to define an area of radio coverage.

In a first embodiment a radio network node, such as the second radio network node 13, transmits an indication indicating DBI associated with or related to at least one DOM of the UE 10, wherein the DBI for a cell indicates whether the UE 10 supporting the DOM associated with the transmitted DBI can access that cell, or not. The indication may for example comprise supported one or more DOMs of the cell and/or one or more DOMs not supported. The DBI information may further comprise cell change information (CCI), wherein the transmitted CCI indicates that upon barring the cell whether the UE can perform cell change to another cell, or not. The CCI may further comprise information about one or more cells to which the UE to perform the cell change upon barring the cell based on the received DBI. Prior to transmitting the DBI and/or CCI for a cell, the radio network node may determine the DBI and/or CCI for the cell based on one or more criteria or scenarios, e.g., whether the cell can schedule mixture of UEs capable of different duplex operational modes.

In a second embodiment, a second network node (NW2), such as the second radio network node 13, transmits a DBI associated with or related to at least one DOM, for a cell, e.g., cell2, to a first network node (NW1), such as the first radio network node 12, which first network node may use it for one or more tasks e.g. for cell change of the UE 10 to cell2. NW2 may further transmit the CCI associated with the DBI to NW1, which may further use it for one or more tasks.

In a third embodiment the UE 10 obtains a DBI associated with or related to at least one DOM in a second cell (cell2) and uses the obtained DBI for determining whether the UE can access cell2 or not. The UE 10 may further obtain cell change information (CCI) and use the obtained CCI for determining that, upon barring cell2, whether the UE 10 can perform cell change to another cell. The UE 10 may further obtain information about a third cell (cell3) and upon barring cell2, the UE 10 may perform cell change to cell3. The UE 10 may further store the obtained DBI and/or CCI and may use it for one or more additional operational tasks, e.g., the UE 10 may store them as part of self organizing network (SON)/minimization of drive test (MDT) and transmit the results to the network when in radio resource control (RRC) connected state.

In one example, the UE 10 may obtain DBI and/or CCI by receiving it from a cell which is being managed, served or controlled by a network node. In this case, in one example the DBI and/or CCI may be received by the UE 10 from cell2 while the UE 10 is served a first cell (cell1), e.g., cell2 is target cell during a cell change procedure. In another example the DBI and/or CCI may be received by the UE from cell2 while the UE 10 is not served by any cell e.g. cell2 is cell for initial access during initial access or cell selection procedure. In another example, the UE 10 may obtain DBI and/or CCI based on pre-configured information e.g. retrieving from the SIM, eSIM or USIM card.

Examples of DOM of a UE are, HD-FDD, FDD, Full duplex (FD), TDD, combination of UE receiver configuration and any of the DOM of the UE 10, e.g. HD-FDD for UE with 1Rx, HD-FDD for UE with 2Rx etc.

Examples of cell change operations are cell reselection, RRC connection release with redirection, RRC connection re-establishment, handover, serving cell change etc.

Examples of the UE receiver configuration may correspond to a number of receivers or receive chains in the UE 10. In one example Rx1, Rx2, Rx4 and Rx8 may correspond to 1 receiver, 2 receivers, 4 receivers and 8 receivers respectively. In another example the UE 10 receiver configuration may correspond to whether the UE receiver can mitigate interference and/or type of interference mitigation mechanism etc.

It is herein provided a mechanism that allows the network to bar or forbid access to a cell, e.g., served by a legacy base station (BS), which does not support or cannot efficiently serve the UE 10 capable of certain type of duplex operation, e.g., legacy FDD cell may not support scheduling UE with HD-FDD operation. This allows the UE 10 to access another cell which can serve the UE 10 more efficiently.

Embodiments herein allow the network to bar the UE 10 from accessing a cell which does not support a certain type of duplex operation. This is especially beneficial for the legacy radio network nodes which may not support certain duplex operation of the UE 10.

Embodiments herein enhance the UE 10 performance since the UE 10 does not access any cell which cannot serve or cannot serve efficiently with certain duplex operation supported by the UE 10.

The overall user and system throughput are enhanced since the UE 10 will not lose data or miss the scheduling in a cell which does not support the certain duplex operation of the UE 10.

The UE mobility performance is enhanced since the UE 10 may be served only by the cell which can serve the UE 10 according to the duplex operation supported by the UE 10. For example, the serving cell will avoid scheduling the uplink transmission for HD-FDD UE during the resources containing reference signals, e.g., synchronization signal block (SSB), used for the measurements.

Embodiments herein enable a gradual roll out of new features that use certain duplex mode in existing network deployment.

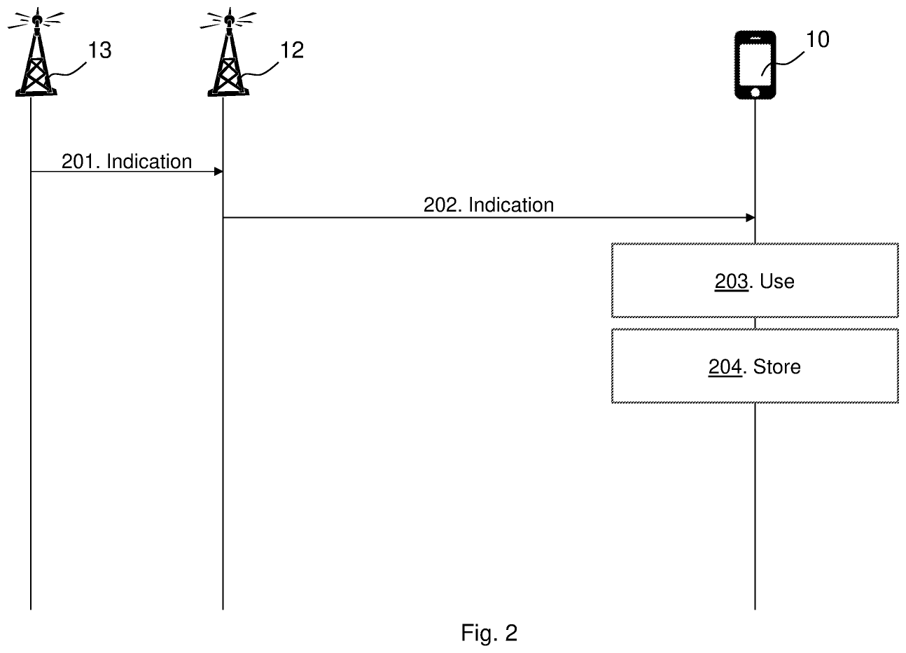

FIG. 2 is a combined signalling scheme and flowchart depicting embodiments herein.
Action 201. The first radio network node 12 may receive the indication from the second radio network node 13. The indication indicates information relating to duplex barring information for a cell served by the second radio network node 13, wherein the DBI is associated with or related to at least one DOM of the UE 10. The DBI may further comprise information relating to cell change information.
Action 202. The first radio network node 12 may transmit the indication in the first cell. The indication indicates information relating to duplex barring information for a cell served by the second radio network node 13, wherein the DBI is associated with or related to at least one DOM of the UE 10. The UE 10 may further obtain cell change information (CCI). The UE 10 may further obtain information about a third cell (cell3) and upon barring cell2, the UE may perform cell change to cell3.
Action 203. The UE 10 uses the obtained DBI for determining whether the UE 10 can access a cell or not. The UE 10 may further use the obtained CCI for determining that, upon barring a cell, whether the UE can perform cell change to another cell. The UE 10 may further obtain information about a third cell and upon barring a cell, the UE 10 may perform cell change to the third cell.
Action 204. The UE 10 may further store the obtained DBI and/or CCI and may use it for one or more additional operational tasks, e.g., store them as part of SON/MDT and transmit the results or indication to the network when in the RRC connected state.

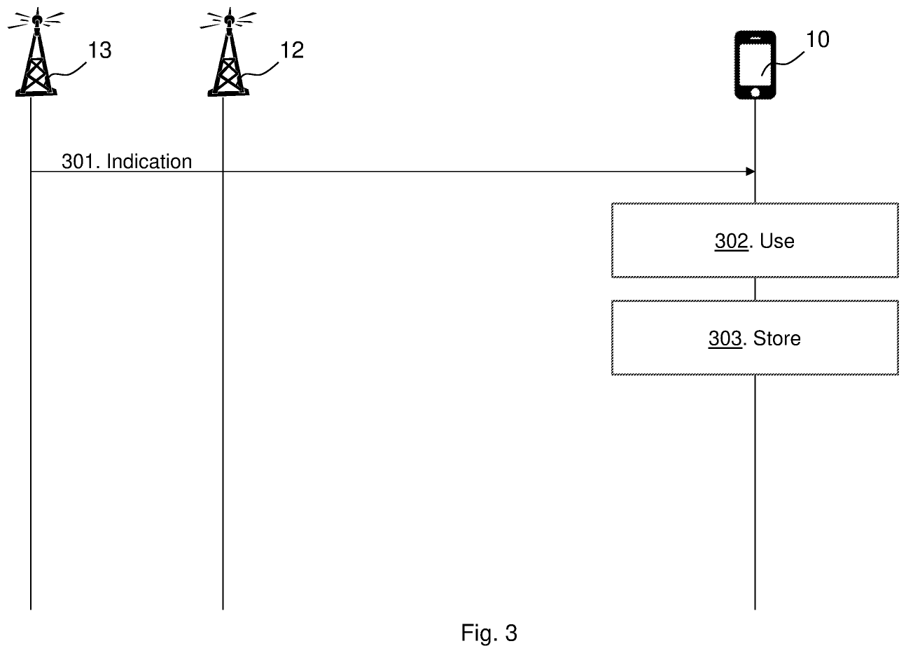

FIG. 3 is a combined signalling scheme and flowchart depicting embodiments herein.
Action 301. The second radio network node 13 may transmit the indication in the second cell. The indication indicates information relating to duplex barring information for the second cell served by the second radio network node 13, wherein the DBI is associated with or related to at least one DOM of the UE 10. The UE 10 may further obtain CCI from the DBI. The UE 10 may further obtain information about a third cell (cell3) and upon barring cell2, the UE 10 may perform cell change to cell3.
Action 302. The UE 10 uses the obtained DBI for determining whether the UE 10 can access a cell or not. The UE 10 may use the obtained CCI for determining that, upon barring a cell, whether the UE can perform cell change to another cell. The UE 10 may further obtain information about a third cell and upon barring a cell, the UE 10 may perform cell change to the third cell.
Action 303. The UE 10 may further store the obtained DBI and/or CCI and may use it for one or more additional operational tasks, e.g., store them as part of SON/MDT and transmit the results or indication to the network when in the RRC connected state.

In this disclosure a term node is used which can be a network node (radio network node) or a user equipment (UE).

Examples of network nodes or radio network nodes are NodeB, base station (BS), multi-standard radio (MSR) radio node such as MSR BS, eNodeB, gNodeB, master eNodeB (MeNB), secondary eNodeB (SeNB), location measurement unit (LMU), integrated access backhaul (IAB) node, network controller, radio network controller (RNC), base station controller (BSC), relay, donor node controlling relay, satellite node, non-terrestrial network (NTN) node, high altitude platform (HAPS) node, base transceiver station (BTS), Central Unit (e.g. in a gNB), Distributed Unit (e.g. in a gNB), Baseband Unit, Centralized Baseband, C-RAN, access point (AP), transmission points, transmission nodes, transmission reception point (TRP), RRU, RRH, nodes in distributed antenna system (DAS), core network node, e.g., Mobility Management Entity (MME), mobile switching center (MME) etc, operations and maintenance (O&M), OSS, SON, positioning server (e.g. LMF, E-SMLC), etc.

The non-limiting term UE refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, internet of things (IoT) capable device, tablet, mobile terminals, smart phone, laptop embedded equipment (LEE), laptop mounted equipment (LME), USB dongles etc.

The term radio access technology, or RAT, may refer to any RAT e.g. UTRA, E-UTRA, narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The term signal or radio signal used herein can be any physical signal or physical channel. Examples of DL physical signals are reference signal (RS) such as primary synchronization signal (PSS), secondary synchronization signal (SSS), CSI-RS, DMRS signals in SS/PBCH block (SSB), discovery reference signal (DRS), CRS, PRS etc. RS may be periodic e.g. RS occasion carrying one or more RSs may occur with certain periodicity e.g. 20 ms, 40 ms etc. The RS may also be aperiodic. Each SSB carries NR-PSS, NR-SSS and NR-physical broadcast channel (PBCH) in 4 successive symbols. One or multiple SSBs are transmit in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprises parameters such as SMTC periodicity, SMTC occasion length in time or duration, SMTC time offset with regards to reference time, e.g. serving cell's SFN, etc. Therefore, SMTC occasion may also occur with certain periodicity e.g. 5 ms, 10 ms, 20 ms, 40 ms, 80 ms and 160 ms. Examples of UL physical signals are reference signal such as SRS, DMRS etc. The term physical channel refers to any channel carrying higher layer information, e.g., data, control etc. Examples of physical channels are PBCH, narrow band physical broadcast channel (NPBCH), physical downlink control channel (PDCCH), physical downlink shared channel (PDSCH), short physical uplink control channel (sPUCCH), short PDSCH, short physical uplink shared channel (sPUSCH), MTC physical downlink control channel (MPDCCH), narrowband PDCCH (NPDCCH), narrowband PDSCH (NPDSCH), Enhanced-PDCCH, physical uplink shared channel (PUSCH), physical uplink control channel (PUCCH), Narrowband PUSCH (NPUSCH) etc.

The term time resource used herein may correspond to any type of physical resource or radio resource expressed in terms of length of time. Examples of time resources are: symbol, sub-slot, mini-slot, time slot, subframe, radio frame, transmission time interval (TTI), interleaving time, frame, SFN cycle, hyper-SFN cycle, etc.

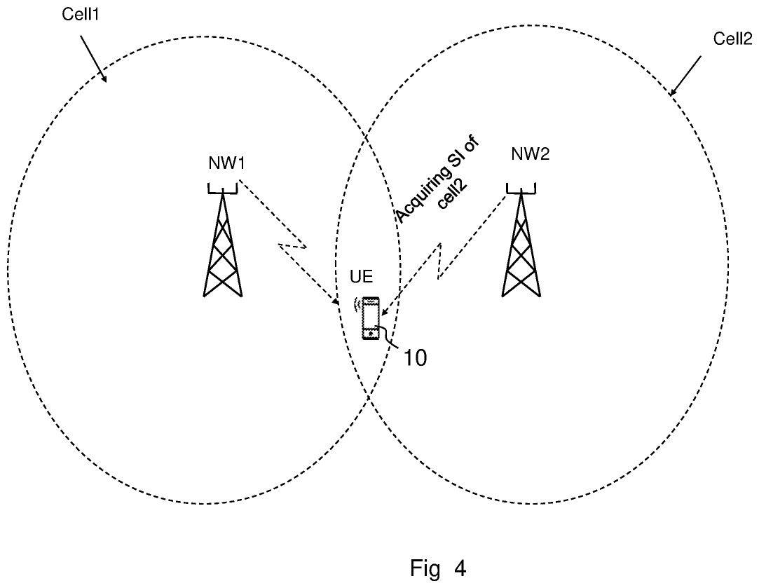

In some embodiment a scenario comprising the UE 10, which is served by a first cell (cell1), which is managed or served or controlled by a first network node (NW1), see FIG. 4. The UE 10 is further configured to perform a cell change to a second cell (cell2), which is managed or served or controlled by a second network node (NW2). In one example cell1 and cell2 operate or belong to the same carrier frequency e.g. first carrier frequency (F1). In another example cell1 and cell2 operate or belong to different carrier frequencies, e.g., on F1 and second carrier frequency (F2) respectively. An example of this scenario is illustrated in FIG. 4. In one example, the NW1 and NW2 are the same, e.g., same physical node and/or same logical node e.g. NW1=NW2. In another example, the NW1 and NW2 are different nodes e.g. different physical and logical nodes. In one example, the cell change may be triggered autonomously by the UE 10 e.g. based on comparison between one or more received signal level measurements (Sr) performed by the UE 10 on reference signal (RS) of cell1 and their respective thresholds and/or comparison between one or more Sr performed by the UE 10 on cell2 and their respective thresholds. In another example, the cell change is triggered based on a message (e.g. cell change command) received from a network node (e.g. NW1). Examples of Sr are measurements such as signal strength (SS), signal quality (SQ) etc. Examples of SS are path loss, reference signal received power (RSRP), SS-RSRP etc. Examples of SQ are reference signal received quality (RSRQ), SS-RSRQ, signal to noise ratio (SNR), signal to interference plus noise ratio (SINR) etc. The UE 10 may further be configured to obtain a system information (SI) of cell2 before performing the cell change to cell2. At least some of the contents of the obtained SI of cell2 may determine whether the UE 10 can or cannot perform cell change to cell2. Therefore, triggering the cell change may or may not result in successful cell change to cell2. Cell1 may also be called as old serving cell. The UE 10 may or may not continue to be served by cell1 even if the UE the cell change to cell2 is unsuccessful. In one example the UE 10 is configured to operate in a low activity RRC state e.g. in RRC idle, RRC inactive. In another example the UE 10 is configured to operate in high activity RRC state e.g. RRC connected. In high activity RRC state in one example the UE may be configured with one serving cell e.g. only with cell1. In another example, in high activity RRC state the UE 10 may be configured with two or more serving cells (e.g. cell11, cell12), and so on.

The UE 10 may be configured with multiple serving cells using multicarrier (MC) operation. Examples of MC operations are carrier aggregation (CA), multi-connectivity (MuC) etc. An example of MuC is dual connectivity (DC). Examples of DC are multi RAT (MR)-DC, NR-DC, EN-DC, NE-DC etc. Examples of serving cells are serving(s) primary cell (PCell), secondary cell (SCell) etc. Examples of sPCell are PCell, PSCell etc. Examples of cell change procedures are cell reselection, RRC connection release with redirection, RRC connection re-establishment, handover, serving cell change, e.g. sPCell change, SCell change, etc.

FIG. 4 is an example of scenario where the UE 10 is served by cell1 and is configured to perform a cell change to a target cell, e.g., second cell (cell2). The UE 10 acquires SI of cell2 before the cell change to cell2.

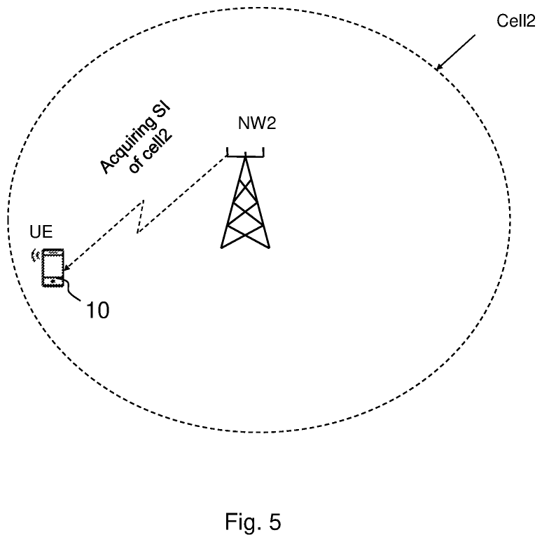

In some embodiments a scenario regards the UE 10, which is not currently served by any cell. The UE 10 is further configured to select a second cell (cell2) e.g. during initial access procedure. An example of this scenario is illustrated in FIG. 5. The cell selection procedure may be triggered autonomously by the UE 10 or based on pre-configured information in the UE 10, e.g., information stored in the UE's SIM or USIM card. The UE 10 may further be configured to obtain the SI of cell2 upon meeting the cell selection criterion e.g. based on comparison between one or more received signal level measurements (Sr) and one or more thresholds. Depending on at least some of the contents of the obtained SI of cell2 the UE 10 may or may not be able to successfully perform cell selection to cell2. The UE 10 will then discard the access of cell2 and perform the cell search to find another suitable cell (cell 1). The ‘suitable cell’ means the cell can support UE's DOM and the signal quality for the cell is also met the cell selection criterion e.g. S criteria. Examples of cell selection procedures are initial cell search, frequency search, initial cell reselection, cell selection for selected PLMN etc. The UE 10 may be triggered to perform the cell selection procedures in one or more scenarios e.g. after losing the serving cell, after the UE 10 is powered on etc.

FIG. 5 shows an example of scenario where the UE 10 is not served by any cell and is configured to select a target cell, e.g., second cell (cell2). The UE 10 acquires SI of cell2 before the cell selection to cell2.

The UE 10 may be capable of or support one or more receiver configurations (Rx). The UE receiver configuration may further depend on frequency band supported by the UE 10. In one example the UE receiver configuration may correspond to number of receiver branches or receiver chains supported by the UE 10. In another example the UE receiver configuration may be related to the ability of the receiver to mitigate interference e.g. partially or fully cancel interference, minimize interference, reject interference etc. In one example the UE 10 may be capable of or support one receiver configuration comprising one or more Rx branches e.g. 1 Rx or 2 Rx or 4 Rx. In another example the same UE 10 may be capable of or support multiple receiver configurations each comprising one or more Rx branches (e.g. 1 Rx and 2 Rx; or 1Rx and 4 Rx, or 2 Rx and 4 Rx etc). The receiver type configuration may also change over time dynamically or semi-statically e.g. after 1 or multiple time resources. The configured receiver type is used by the UE for receiving one or more signals e.g. RS such as SSB, CSI-RS and/or channels e.g. PBCH, PDCCH, PDSCH etc.

The embodiments are applicable to all the scenarios described above. In the embodiments the term “cell change” to certain target cell (e.g. cell2) may also refer to cell selection to the target cell (e.g. cell2). Therefore, the embodiments are applicable regardless of whether the UE is served by a cell (e.g. cell1) or is not served by any cell (e.g. performing initial cell selection).

### Embodiment #1: Method in a Network Node of Determining and Transmitting Duplex Barring Information to a UE

In one aspect of a first embodiment a network node, such as the first radio network node 12 or the second radio network node 13, transmits a DBI for a cell (e.g. second cell (cell2) and is associated with or related to at least one DOM configured at a UE 10. The configured DOM may correspond to UE capability, or it can be dynamically or semi-statically configured based on one or more criteria (as described above). The DBI enables the UE 10, which by comparing its supported DOM to the received DBI, to determine whether the UE 10 can access the cell for which the DBI is transmitted by the network node (i.e. UE in RRC_IDLE or RRC_INACTIVE). In RRC_CONNECTED it can be left to the network to configure DOM for the UE 10 if it is capable of more than one, e.g., configuring HD-FDD for the UE 10 even if the UE 10 is capable of FD-FDD. In this case, the DBI information may further be associated with the configured DOM and the UE receiver configuration (Rx). The UE 10 can be configured with certain DOM and/or certain receiver configuration autonomously or based on information received from a network node.

In a RedCap specific example of this embodiment, gNB indicates in SIB1 if HD-FDD operation is enabled in the cell using the parameter hdFDDredcap and RedCap UEs which only support HD-FDD shall only consider the cell for (re-)selection if this parameter is not set to value barred, see ASN. 1 example below. The network can schedule the RedCap UE with the reasonable random access channel (RACH) resources to avoid the SIB information reception.

In another RedCap specific example of this embodiment, gNB indicates in MIB if HD-FDD operation is enabled in the cell hdFDDredcap and RedCap UEs which only support HD-FDD shall only consider the cell for (re-)selection if this parameter is not set to value barred.

In another RedCap specific example of this embodiment, in CONNECTED mode, the network may configure the UE 10 to perform cell change, e.g., handover, to a cell which is more efficient, e.g., more suitable for data reception, have higher signal quality etc, than current the serving cell. The network may configure the DOM and CCI information to the UE 10 together with the cell change command, e.g., handover command. The UE 10 will select a ‘suitable cell’ as part of the cell change, e.g., handover, and camp on or be served by it.

In a second aspect of the first embodiment the network node may further transmit a CCI to the UE 10 from the same cell transmitting the DBI. The CCI may be associated with certain DBI. The CCI may be used by the UE 10 if the UE 10 cannot access the cell as indicated by the DBI. The CCI enables the UE 10 to determine whether the UE 10 can perform cell change to another cell or not. The CCI may further enable the UE 10 to determine whether the UE 10 can perform cell change to another cell or not, on the carrier frequency of the cell, e.g., cell2, for which the associated DBI is transmitted, e.g., whether the intra-frequency/inter-frequency cell reselection is allowed or not. The CCI may further comprise information about at least one cell, e.g., a third cell (cell3)) which can be accessed by the UE 10 using the DOM, which is not allowed in cell2, as indicated by DBI. The cell information, e.g., about cell3, may comprise one or more of e.g. cell ID, e.g., PCI, CGI, carrier frequency of cell3, e.g., carrier frequency channel number such as ARFCN, NR-ARFCN etc, etc. In a RedCap specific example of this embodiment, CCI can be implemented by indicating the DBIs of the neighbor cells in system information, i.e., added to SIB3 for intra-frequency and to SIB4 for inter-frequency re-selection, respectively. In this way a RedCap UE supporting only HD-FDD would not consider neighbour cells not supporting HD-FDD from cell re-selection and thereby time and energy wasted on acquiring SI of each of these cells can be omitted.

In general the DBI may consist of a flag or a DBI indicator, which may be transmitted in system information (SI) or master information (MI) of a cell to the UE 10. Alternatively, the DBI indicator may also be a scrambling sequence to the PSS/SSS in SS block which is transparent to the legacy network. The CCI may be transmitted in SI of a cell to the UE 10. The DBI and CCI may be transmitted via higher layer signalling, e.g., via RRC in the SI, e.g., in a SIB such as SIB1. In one example DBI and/or CCI are transmitted in the same cell for which the DBI and/or CCI are applicable, e.g., DBI and/or CCI for cell2 is transmitted in cell2, e.g., in the SI of cell2. In another example DBI and/or CCI are transmitted in a cell which is different than the cell for which the DBI and/or CCI are applicable, e.g., DBI and/or CCI for cell2 is transmitted in cell1 e.g. in the SI of cell1, in cell change command or message, e.g., in a handover (HO) command.

In one example, the DBI for a cell may be configured as ‘barred’. In this case the UE receiving the DBI and supporting a DOM corresponding to the received DBI is not permitted to access that cell. But if the UE 10 does not receive the DBI then the UE 10 can access the cell. This example is shown in Table 1, where the transmitted DBI is for a target cell, e.g., cell2. In another example the DBI may be configured as ‘barred or ‘not barred’, e.g., ‘unbarred’. In this case the UE 10 receiving the DBI and supporting a DOM corresponding to the received DBI shall not access that cell if the DBI is set to ‘barred’. But the UE 10 can access that cell if the received DBI is set to ‘not barred’. This example is shown in Table 2, where the transmitted DBI is also for a target cell e.g. cell2. The ‘barred’ and ‘not barred’ may also be signalled in terms of 1 or more bits, e.g., 0 and 1 indicating ‘not barred’ and barred respectively or vice versa. In another example, the DBI for a cell may be configured as ‘not barred’. In this case the UE 10 receiving the DBI and supporting a DOM corresponding to the received DBI is permitted to access that cell. But if the UE 10 does not receive the DBI then the UE 10 cannot access the cell considering that it won't be possible for legacy cells to indicate the DBI. This example is shown in Table 3, where the transmitted DBI is for a target cell, e.g., cell2. In another example, the DBI for a cell may be configured as ‘not barred’. In this case the UE 10 receiving the DBI and supporting a DOM corresponding to the received DBI is permitted to access that cell. But if the UE 10 does not receive the DBI then the UE 10 still can access the cell considering that it won't be possible for legacy cells to indicate the DBI. This example is shown in Table 4, where the transmitted DBI is for a target cell, e.g., cell2.

TABLE 1
Example of UE action for UE configured with DOM, such as
HD-FDD, associated with DBI based on DBI transmission.

| | DBI field setting for | |
|---|---|---|
| No | cell2 | UE access status for cell2 |
| 1 | Barred | Access to cell2 is not allowed for UE |
| | | configured with DOM associated with DBI |
| 2 | Not transmitted | Access to cell2 is allowed even for UE |
| | | configured with DOM associated with DBI |

TABLE 2
Example of DBI setting for cell2 and corresponding UE
action for UE configured with DOM associated with DBI.

| | DBI field setting for | |
|---|---|---|
| No | cell2 | UE access status for cell2 |
| 1 | Barred | Access to cell2 is not allowed for UE |
| | | configured with DOM associated with DBI |
| 2 | Not barred | Access to cell2 is allowed even for UE |
| | | configured with DOM associated with DBI |

TABLE 3
Example of UE action for UE configured with DOM
associated with DBI based on DBI transmission.

| | DBI field setting for | |
|---|---|---|
| No | cell2 | UE access status for cell2 |
| 1 | Not Barred | Access to cell2 is allowed for UE |
| | | configured with DOM associated with DBI |
| 2 | Not transmitted | Access to cell2 is NOT allowed even for UE |
| | | configured with DOM associated with DBI |

TABLE 4
Example of UE action for UE configured with DOM
associated with DBI based on DBI transmission.

| | DBI field setting for | |
|---|---|---|
| No | cell2 | UE access status for cell2 |
| 1 | Not Barred | Access to cell2 is allowed for UE |
| | | configured with DOM associated with DBI |
| 2 | Not transmitted | Access to cell2 is allowed even for UE |
| | | configured with DOM associated with DBI |

The DBI may be provided implicitly via configuration for preamble partitioning based on what sort of duplex operation is supported/allowed in the cell. Such configuration may be transmitted to the UE 10 as part of the SI of the cell. When such configuration is provided the UE 10 may trigger a random access procedure to establish an RRC connection by transmitting a preamble selected from a set of preambles configured or allocated for a particular duplex operation, e.g., a set pf preambles allocated for HD-FDD operation which indicates that the network supports such operation and when received by the radio network node it is an indication from the UE 10 regarding what it supports and the mode of duplex operation that the UE 10 would like to use when establishing such connection. In another example the partitioning may be based on, not only the individual duplex operations, but a combination of those, e.g., a preamble set allocated to indicate that HD-FDD and FDD duplex operations are supported in the cell implicitly and provide means for the UE 10 to indicate its supported/preferred mode of duplex operation for and during connection establishment.

Prior to transmitting the DBI and/or CCI for a cell to the UE 10, the radio network node may determine the DBI and/or CCI for the cell based on one or more criteria or scenarios or rules or principles. Examples of criteria or scenarios are:
In one example, the determination of the DBI is based on whether the base station managing or serving a cell can support UE with certain type of duplex operation, e.g., HD-FDD, FDD etc., or not in the operating frequency band. For example, the base station may have legacy implementation, which can support only legacy UEs, e.g., FDD capable UE. In this case the radio network node may decide to set DBI for that cell as barred for a UE supporting at least one type of certain duplex operation, e.g., HD-FDD UE; otherwise the DBI is set to ‘not barred’ or may not be transmitted.
In another example, the determination of the DBI is based on whether the base station managing or serving a cell can support mixture of the UEs with two or more types of duplex operation, e.g., HD-FDD, FD etc., or not. For example, if the base station cannot support mixture of UEs in a cell, e.g. cannot support FDD and HD-FDD UEs in the same cell, then the radio network node may set DBI in a cell for at least one type of duplex operation of the UE as barred. The radio network node may decide which one or more type of duplex operations of the UEs are barred based on one or more criteria, e.g., based on number of UEs in the cell, cell load, e.g., number of physical channels currently used in the cell etc. For example, the DBI may be set to barred for the duplex operational mode with least number of UEs in the cell. This will allow the radio network node to serve majority or large number of UEs in the cell.
In another example, the determination of the DBI is based on receiving information from another radio network node, e.g., centralized node. For example, the centralized node may store information about the barring status for different duplex operations in different cells.
In another example, the determination of the DBI is based on number of UEs currently being served or expected to be served by a cell. The information about the number of UEs being served by the cell can be obtained by retrieving the UE context information stored in the network, e.g., in a base station, core network node, e.g., MME, Access and Mobility Management Function (AMF) etc. The information about the number of UEs expected to be served by the UE 10 can be obtained based on one or more of: the history, statistics, UE requests received for connection, e.g., random access, geographical location of the cell, time of the day (e.g. typical number of UEs in certain hours etc) etc. For example, if the number of UEs currently being served or expected to be served by the cell is above certain threshold then the radio network node may decide to set DBI for that cell as barred for a UE supporting at least one type of certain duplex operation, e.g. HD-FDD UE; otherwise the DBI is set to ‘not barred’ or may not be transmitted.
In another example, the determination of the DBI is based on resources in the base station serving the cell whose DBI is to be transmitted. Examples of resources are hardware resources, e.g., processors, memory units etc., radio resources, e.g., cell bandwidth, number of physical resources such as resource blocks, transmission power level etc., logical channels, e.g., channels for control, data etc. The resources herein may refer to any one or more of: total resource capacity of the radio network node, currently available resources, currently unavailable resources, average resources being used, average resources not being used etc. For example, if the currently available resources and/or averaged resources not being used are below their respective thresholds for a cell then the radio network node may decide to set DBI for that cell as barred for a UE supporting at least one type of certain duplex operation (e.g. HD-FDD UE); otherwise the DBI is set to ‘not barred’ or may not be transmitted.
In another example, the radio network node may transmit the CCI based on whether one or more cells on a carrier frequency (e.g. F2) of cell2, can serve the UE with the DOM, which cannot be used in cell2. In another example, the radio network node may transmit the CCI based on whether there is one or more cells which do not transmit DBI as barred as transmitted by cell2. The radio network node may obtain the DBI information transmitted in different cells by receiving them from different cells or by receiving them from a node, e.g., from a centralized node, which contains this information or based on a rule. In one example of the rule, that the same DBI is transmitted in all the cells or at least in subset of cells, e.g., cells in geographical region such as a city, on the same carrier frequency. For example, if all the cells on F2 are transmitting DBI to bar the access of the UE from using the same DOM then the radio network node may send CCI indicating that the UE shall not perform cell change to any cell of the carrier frequency of cell2. Otherwise, the transmitted CCI may indicate that the UE 10 can perform cell change to another cell of the carrier frequency of cell2.
In another example, the determination of the DBI is based on a license condition of the operating frequency band in the cell where DBI is transmitted. An example of the license condition is that FD is allowed only in a certain area, e.g., indoor. For example, if the radio network node operating is in indoors of a building where FD is allowed. But in the outdoors, e.g., just next to the outdoor site, where FD is not allowed, this radio network node may decide to set DBI for that cell as barred for the UE 10. This will enable the FD operation to avoid the interference to the radio network node outside the building.

Each DBI flag may define a mapping or relation or association with at least one DOM supported by the UE e.g. one DPI for HD-FDD capable UE. In another example the same DBI flag may be associated with multiple types of duplex operational capabilities of the same UE or of different UEs, e.g., one DBI for HD-FDD and FD capable UEs. The DOM can be UE capability, which can be signalled to the radio network node or pre-defined, e.g., declared by the UE in a specification. Examples of different DBIs and corresponding DOMs are described below:
A general example of set of N number of DBIs (DBI1, DBI2, . . . , DBIN) corresponding to N different DOMs (DOM1, DOM2, . . . , DOMN) for a cell (e.g. cell2) is shown in Table 5. Each DBI indicates whether the UE 10 can access cell2 or not, e.g., access not allowed when using DOM i when DBI i is configured or set as ‘barred’.
Another general example of set of K number of DBIs (DBI1, DBI2, . . . , DBIK) associated with corresponding K combined set of N different DOMs (DOM1, DOM2, . . . , DOMN) and M different UE receiver configurations (Rx1, Rx2, . . . , RxM) for a cell (e.g. cell2) is shown in Table 6, where K=N*M. Each DBI indicates whether the UE 10 can access cell2 or not e.g. access not allowed when using set j of DOM and Rx when DBI j is configured or set as ‘barred’.
Another general example of set of L number of DBIs (DBI1, DBI2, . . . , DBIL) corresponding to N different DOMs (DOM1, DOM2, . . . , DOMN) and combined set of N different DOMs (DOM1, DOM2, . . . , DOMN) and M different UE receiver configurations (Rx1, Rx2, . . . , RxM) for a cell (e.g. cell2) is shown in Table 7. Where L=N (1+M). Each DBI indicates whether the UE 10 can access cell2 or not e.g. access not allowed when using set p of DOMs or combination of DOMs and Rx when DBI p is configured or set as ‘barred’. The example in Table 7 is combination of DBIs on Tables 5 and 6.
A specific example of 4 different DBIs (DBI1, DBI2, DBI3, DBI4) corresponding to 4 different DOMs (HD-FDD, FDD, TDD, FD) respectively for a cell (e.g. cell2) is shown in Table 8. For example, if DBI1 transmitted for cell2, e.g., by cell2 or by another cell for cell2, is set as ‘barred’ then the UE 10 configured with HD-FDD mode is not allowed to access cell2. A cell capable of FD operation may be able to serve UEs with all different DOMs or subset of the DOMs. In one example, FD capable cell may support UE configured with FD as well as FDD. In this case it may transmit DBI1 and DBI3 which are set as ‘barred’ to prevent UEs configured with HD-FDD and TDD from accessing the cell, e.g., cell2. In another example, while FD capable cell may support operation of all the DOMs but may deliberately bar UEs configured with certain DOMs based on one or more criteria e.g. to reduce cell load (e.g. number of UEs), load balancing across cells (e.g. distribute UEs with different DOMs in different cells) etc.
Another specific example of 12 different DBIs (DBI1, DBI2, . . . , DBI12) corresponding to 4 DOMs (HD-FDD, FDD, TDD, FD) or 8 different combined set of 4 DOMs (HD-FDD, FDD, TDD, FD) and 2 receiver configurations (Rx1, Rx2) for a cell (e.g. cell2) is shown in Table 9. For example, if DBI5 transmitted for cell2 (e.g. by cell2 or by another cell for cell2) is set as ‘barred’ then the UE 10 configured with HD-FDD mode and 1Rx is not allowed to access cell2.
An example of the RRC signalling (e.g. required ASN. 1 changes in Rel-17) required in the latest version of TS 38.331 v16.7.0, to bar access of a UE configured with or capable of HD-FDD in a cell is shown below. The addition related to embodiments herein are shown in bold font and underlined marked.

TABLE 5
General examples of DBI set i associated with UE's DOM set i

| | DBI | |
|---|---|---|
| No | set i | Purpose/meaning of DBI set i |
| 1 | DBI1 | Whether UE access to cell2 is allowed for UE |
| | | configured with DOM1 associated with DBI1 |
| 2 | DBI2 | Whether UE access to cell2 is allowed for UE |
| | | configured with DOM2 associated with DBI2 |
| ¼ | ¼ | . . . |
| N | DBI_{N} | Whether UE access to cell2 is allowed for UE |
| | | configured with DOM_{N} associated with DBI_{N} |

TABLE 6
General examples of DBI set i associated with
UE's DOM and receiver configuration (Rx) set i

| | DBI | |
|---|---|---|
| No | set i | Purpose/meaning of DBI set i |
| 1 | DBI1 | Whether UE access to cell2 is allowed for UE |
| | | configured with DOM1 and Rx1 associated with DBI₁ |
| 2 | DBI2 | Whether UE access to cell2 is allowed for UE |
| | | configured with DOM1 and Rx2 associated with DBI₂ |
| ¼ | ¼ | . . . |
| M | DBI_{M} | Whether UE access to cell2 is allowed for UE |
| | | configured with DOM1 and Rx_{M} associated with DBI_{M} |
| M + | DBI_{M+1} | Whether UE access to cell2 is allowed for UE |
| 1 | | configured with DOM2 and Rx1 associated with DBI_{M+1} |
| ¼ | ¼ | . . . |
| K | DBI_{K} | Whether UE access to cell2 is allowed for UE |
| | | configured with DOM_{N} and Rx_{M} associated with DBI_{K} |

TABLE 7
General examples of DBI set i associated with UE's DOM or
combined set of UE's DOM and receiver configuration (Rx) set i

| | DBI | |
|---|---|---|
| No | set i | Purpose/meaning of DBI set i |
| 1 | DBI1 | Whether UE access to cell2 is allowed for UE |
| | | configured with DOM1 associated with DBI1 |
| 2 | DBI2 | Whether UE access to cell2 is allowed for UE |
| | | configured with DOM2 associated with DBI2 |
| ¼ | ¼ | . . . |
| N | DBI_{N} | Whether UE access to cell2 is allowed for UE |
| | | configured with DOM_{N} associated with DBI_{N} |
| N + 1 | DBI_{N+1} | Whether UE access to cell2 is allowed for UE |
| | | configured with DOM1 and Rx1 associated with DBI_{N+1} |
| ¼ | ¼ | . . . |
| L | DBI_{L} | Whether UE access to cell2 is allowed for UE |
| | | configured with DOM_{N} and Rx_{M} associated with DBI_{L} |

TABLE 8
Specific examples of DBI set i associated with UE's DOM set i

| | DBI | |
|---|---|---|
| No | set i | Purpose/meaning of DBI set i |
| 1 | DBI1 | Whether UE access to cell2 is allowed for UE configured |
| | | with HD-FDD operation |
| 2 | DBI2 | Whether UE access to cell2 is allowed for UE configured |
| | | with FDD operation |
| 3 | DBI3 | Whether UE access to cell2 is allowed for UE configured |
| | | with TDD operation |
| 4 | DBI4 | Whether UE access to cell2 is allowed for UE configured |
| | | with FD operation |

TABLE 9
Specific example DBI set i associated with UE's
DOM and receiver configuration (Rx) set i

| | DBI | |
|---|---|---|
| No | set i | Purpose/meaning of DBI set i |
| 1 | DBI1 | Whether UE access to cell2 is allowed for UE |
| | | configured with HD-FDD operation |
| 2 | DBI2 | Whether UE access to cell2 is allowed for UE |
| | | configured with FDD operation |
| 3 | DBI3 | Whether UE access to cell2 is allowed for UE |
| | | configured with TDD operation |
| 4 | DBI4 | Whether UE access to cell2 is allowed for UE |
| | | configured with FD operation |
| 5 | DBI5 | Whether UE access to cell2 is allowed for UE |
| | | configured with HD-FDD operation and 1 Rx |
| 6 | DBI6 | Whether UE access to cell2 is allowed for UE |
| | | configured with HD-FDD operation and 2 Rx |
| 7 | DBI7 | Whether UE access to cell2 is allowed for UE |
| | | configured with FDD operation and 1 Rx |
| 8 | DBI8 | Whether UE access to cell2 is allowed for UE |
| | | configured with FDD operation and 2 Rx |
| 9 | DBI9 | Whether UE access to cell2 is allowed for UE |
| | | configured with TDD operation and 1 Rx |
| 10 | DBI10 | Whether UE access to cell2 is allowed for UE |
| | | configured with TDD operation and 2 Rx |
| 11 | DBI11 | Whether UE access to cell2 is allowed for UE |
| | | configured with FD operation and 1 Rx |
| 12 | DBI12 | Whether UE access to cell2 is allowed for UE |
| | | supporting FD operation and 2 Rx |

SIB1 message
-- ASN1START
-- TAG-SIB1-START

| SIB1 ::= | SEQUENCE { | |
|---|---|---|
| cellSelectionInfo | SEQUENCE { | |
| q-RxLevMin | Q-RxLevMin, | |
| q-RxLevMinOffset | INTEGER (1..8) | OPTIONAL, -- Need S |
| q-RxLevMinSUL | Q-RxLevMin | OPTIONAL, -- Need R |
| q-QualMin | Q-QualMin | OPTIONAL, -- Need S |
| q-QualMinOffset | INTEGER (1..8) | OPTIONAL -- Need S |
| } | | OPTIONAL, -- Cond Standalone |
| cellAccessRelatedInfo | CellAccessRelatedInfo, | |
| connEstFailureControl | ConnEstFailureControl | OPTIONAL, -- Need |

R

| | | |
|---|---|---|
| si-ScheduleingInfo | SI-SchedulingInfo | OPTIONAL, -- Need R |
| servingCellConfigCommon | ServingCellConfigCommonSIB | OPTIONAL, - |

- Need R

| | | |
|---|---|---|
| ims-EmergencySupport | ENUMERATED {true} | OPTIONAL, -- |

Need R

| | | |
|---|---|---|
| eCallOverIMS-Support | ENUMERATED {true} | OPTIONAL, -- |

Need R

| | | |
|---|---|---|
| ue-TimersAndConstants | UE-TimersAndConstants | OPTIONAL, -- |

Need R

| uac-BarringInfo | SEQUENCE { | |
|---|---|---|
| uacBarringForCommon | UAC-BArringPerCatList | OPTIONAL, -- |

Need S

| | | |
|---|---|---|
| uac-BarringPerPLMN-List | UACBarringPerPLMN-List | OPTIONAL, -- |

Need S

| | |
|---|---|
| uac-BarringInfoSetList | UAC-BarringInfoSetList, |

uac-AccessCategory1-SelectionAssistanceInfo CHOICE {

| | |
|---|---|
| plmnCommon | UAC-AccessCategory1-SelectionAssistanceInfo, |
| individualPLMNList | SEQUENCE (SIZE (2..maxPLMN)) OF UAC-AccessCategory1- |

SelectionAssistanceInfo

| | | |
|---|---|---|
| } | | OPTIONAL -- Need S |
| } | | OPTIONAL, -- Need R |
| useFullResumeID | ENUMERATED {true} | OPTIONAL, -- Need |

R

| | | |
|---|---|---|
| lateNonCriticalExtension | OCTET STRING | OPTIONAL, |
| nonCriticalExtension | SIB1-v1610-IEs | OPTIONAL |

}

| | |
|---|---|
| SIB1-v1610-IEs ::= | SEQUENCE { |

idleModeMeasurementsEUTRA-

| | | |
|---|---|---|
| r16 ENUMERATED{true} | | OPTIONAL, -- Need R |
| idleModeMeasurementsNR-r16 | ENUMERATED{true} | OPTIONAL, -- |

Need R

| | | |
|---|---|---|
| posSI-SchedulingInfo-r16 | PosSI-SchedulingInfo-r16 | OPTIONAL, -- |

Need R

| | | |
|---|---|---|
| nonCriticalExtension | SIB1-v1630-IEs | OPTIONAL |

}

| | |
|---|---|
| SIB1-v1630-IEs ::= | SEQUENCE { |
| uac-BarringInfo-v1630 | SEQUENCE { |
| uac-AC1-SelectAssistInfo-r16 | SEQUENCE (SIZE (2..maxPLMN)) OF UAC-AC1-SelectAssistInfo- |

r16

| | |
|---|---|
| } | OPTIONAL, -- Need R |

| | |
|---|---|
| nonCriticalExtension | [symbol] SIB1-v17xy-IEs |

OPTIONAL
}

| SIB1-v17xy-IEs ::= | SEQUENCE { | |
|---|---|---|
| cellBarredRedcap1Rx-r17 | ENUMERATED{barred} | OPTIONAL, -- |

Need R

| | | |
|---|---|---|
| cellBarredRedcap2Rx-r17 | ENUMERATED{barred} | OPTIONAL, -- |

Need R

| | | |
|---|---|---|
| intraFreqReselection-r17 | ENUMERATED{true} | OPTIONAL, -- |

Need R

| | | |
|---|---|---|
| hdFDDredcap-r17 | ENUMERATED{barred} | OPTIONAL, -- |

Need R

| | | |
|---|---|---|
| nonCriticalExtension | SEQUENCE { } | OPTIONAL |

}

| | |
|---|---|
| UAC-AccessCategory1-SelectionAssistanceInfo ::= | ENUMERATED {a, b, c} |
| UAC-AC1-SelectAssistInfo-r16 ::= | ENUMERATED {a, b, c, notConfigured} |

-- TAG-SIB1-STOP
-- ASN1STOP
SIB1 field descriptions
cellSelectionInfo
Parameters for cell selection related to the serving cell.
:
: <Field description for new IEs start here>
cellBarredRedcap1Rx
Indicates cell barring for RedCap UE with 1 Rx branch. Value barred means that the cell is barred,
as defined in TS 38.304 [20].
cellBarredRedcap2Rx
Indicates cell barring for RedCap UE with 2 Rx branch. Value barred means that the cell is barred,
as defined in TS 38.304 [20].
intraFreqReselection
Controls cell selection/reselection to intra-frequency cells for RedCap type UEs when the highest
ranked cell is barred, or treated as barred by the UE, as specified in TS 38.304 [20]. If this field is
absent, the UE considers the cell does not support RedCap.
hdFDDredcap
Indicates cell barring for RedCap UE not supporting full-duplex FDD. Value barred means that the
cell is barred for RedCap UE only supporting half-duplex FDD, as defined in TS 38.304 [20].
: <Field description for new IEs stop here>
:

Above is an example of changes, underlined, in the latest version of TS 38.331 v16.7.0, to bar access of UE configured with or capable of HD-FDD in a cell.

### Embodiment #2: Method in a Radio Network Node, Such as the First or the Second Radio Network Node, of Determining and Transmitting Duplex Barring Information to Another Network Node

In a second embodiment the radio network node such as a second network node (NW2) transmits a DBI associated with a cell, e.g., second cell (cell2) to another network node, e.g., to a first network node (NW1). The received DBI enables the NW1 to identify the access barring status related one or more DOMs in cell2, e.g., whether cell2 can serve UE configured with certain DOM, e.g., UE configured with HD-FDD, or not. The NW2 may further transmit CCI to the NW1. The received CCI enables the NW1 to identify whether the UE 10 configured with DOM associated with the DBI can perform cell change to another cell if the cell change to cell2 is not successful due to the access barring.

The details related to DBI and CCI in this embodiment are the same as described in the first embodiment. The NW2, before transmitting DBI and CCI to the NW1, may further determine the DBI and the CCI based on one or more criteria, scenarios, rules or principles as described in the first embodiment.

The NW2 may transmit DBI and CCI associated with cell2 to the NW1 using one or more of the following mechanisms:
In one example, the NW2 may transmit DBI and CCI to the NW1 autonomously or proactively, e.g., periodically.
In another example, the NW2 may transmit DBI and CCI to the NW1 when one or more criteria are met, e.g., when the access barring status of cell2 in terms of supported DOMs changes, when the UE 10 is triggered to perform cell change to cell2.
In another example, the NW2 may transmit DBI and CCI to the NW1 upon receiving a request from another network node, e.g., from the NW1. For example, if the NW1 requests the NW2 to provide DBI and CCI for cell2.
In another example, the NW2 may transmit DBI and CCI to the NW1 via signalling over an interface between the NW2 and the NW1, e.g., over Xn interface. This could for example be used upon handover to another cell, in which case gNB would in the handover request over Xn check if the target cells supports the DOM supported by the UE 10 before handing over the UE 10 to the target cell. In the case of RedCap this would correspond to adding, e.g., the parameter hdFDDredcap to the handover request signalling over Xn. In another example, the NW2 may transmit DBI and CCI to the NW1 via signalling via an intermediate node, e.g., via a core network.
   The NW1 may use the received DBI and/or CCI for one or more tasks. Examples of tasks are:
Transmitting the received DBI and/or CCI to the UE 10.
Adapting cell change procedure of the UE 10 configured with DOM corresponding to the received DBI e.g.
   Performing cell change of the UE 10 to a cell different than cell2.
   Postponing cell change of the UE 10 to cell2.
   Requesting the UE 10 to reconfigure its DOM or DOM and receiver, whose access is allowed in cell2. The NW1 may further perform cell change to cell2 if the UE 10 can reconfigure its DOM or DOM and receiver, as requested by the NW1.

### Embodiment #3: Method in the UE 10 of Obtaining and Using DBI for Tasks

In one aspect of a third embodiment the UE 10, configured to access a cell (e.g. cell2), obtains the DBI associated with that cell (e.g. second cell (cell2)) and uses the obtained DBI for performing a first set of one or more tasks. The one or more first set of tasks depend on whether the received DBI is associated with or is related to at least one DOM configured at the UE 10. The UE 10 may further obtain CCI associated with the obtained DBI for cell2 and uses the obtained CCI for performing a second set of one or more tasks.

The UE 10 may obtain DBI and/or CCI by receiving them via signalling, e.g., RRC message, from a network node e.g. from the NW1 and/or the NW2. For example, in low activity RRC state the UE 10 may obtain DBI and CCI by acquiring or receiving the SI of cell2 which is managed by the NW2. In another example, in high activity RRC state, e.g., in RRC connected state, the UE 10 may obtain DBI and CCI by acquiring or receiving a cell change message, e.g., HO command, RRC release message etc., from cell1 which is managed by the NW1. In both cases the DBI enables the UE 10 to identify the cell barring status of cell2 when the UE 10 is configured with certain DOM or combination of certain DOM and UE receiver configuration. Also, in both cases the CCI enables the UE 10 to identify if the UE 10 accesses to another cell, e.g., cell3, if the UE 10 access to cell2 is barred on the basis of the UE's configured DOM or combination of the UE's configured DOM and receiver.

In one specific example, to avoid the UE 10 from missing the DBI and CCI information in SI command, the UE 10 in low activity RRC state will prioritize the CORESET #0 reception than the RACH transmission once the UE 10 detects the overlapping between the CORESET #0 occasion and RACH occasion in time.

In one specific example, to avoid the UE 10 from missing the DBI and CCI information from cell change message in high activity RRC state, the UE 10 may prioritize the downlink reception than the uplink transmission when the UE 10 detecting the received signal level measurements (Sr) is lower than certain threshold. Examples of Sr are measurements such as signal strength (SS), signal quality (SQ) etc. Examples of SS are path loss, RSRP, SS-RSRP etc. Examples of SQ are RSRQ, SS-RSRQ, SNR, SINR etc.

The UE 10 can be configured with certain DOM and/or certain receiver configuration autonomously or based on information received from a network node. The DOM and/or certain receiver configuration can be pre-configured in the UE 10 or it may be dynamically or semi-statically configured in the UE 10 as explained with examples below:
In one example, the configured DOM corresponds to the DOM supported by the UE 10. For example, it corresponds to the UE capability if the UE 10 is capable of one DOM for group of bands or one DOM for certain frequency band.
In another example, the configured DOM corresponds to one of the pluralities of the supported DOM of the UE 10, e.g., if the UE 10 is capable of multiple DOMs for the same band or for different bands. In one example, the UE receiver configuration corresponds to the supported UE receiver configuration or the UE receiver capability, e.g., if the UE 10 is capable of one receiver configuration such as 1 Rx.
In another example, the UE receiver configuration corresponds to one of the pluralities of the UE receiver configurations supported by the UE 10, e.g., if the UE 10 is capable of multiple receiver configurations for same or different bands such as 1 Rx, 2Rx etc. The UE 10 may be configured with certain DOM and/or receiver configuration based on one or more criteria e.g. to reduce power consumption, to reduce baseband processing, to reduce the maximum received/transmitted channel bandwidth, to reduce buffer size/memory usage, to increase user throughput, to increase spectral efficiency, to reduce measurement time, etc.

The explanation and examples, e.g., in Tables 1-7, describing DBI and CCI provided in the first embodiment also apply to this embodiment.

Examples of the first set of one or more tasks performed by the UE 10 based on the received DBI are related to whether the UE 10 can access cell2 or not, are:
In one example if the DBI is not related to the configured DOM or combination of DOM and receiver configuration of the UE 10 then the UE 10 determines that the UE 10 is not forbidden to access cell2 on the basis of its configured DOM or combination of DOM and receiver configuration. For example, if the DBI is related to FDD while the UE 10 is configured with HD-FDD then the UE 10 assumes that the UE can access the cell e.g. cell2. In this case the UE 10 may further access the cell.
In another example if the DBI is related to the configured DOM or combination of DOM and receiver configuration of the UE 10 then the UE 10 determines whether the UE 10 can access cell2 or not. The UE 10 may perform one or more tasks as described below:
   In one example, the UE 10 identifies that the access to cell2 is barred upon reception of DBI, which matches with the configured DOM or combination of DOM and receiver configuration of the UE 10. In this case the DBI may be only transmitted when the access to the UE 10 configured with certain DOM is barred. Therefore the UE 10 can access cell2 if the UE 10 does not receive DBI for cell2.
   In another example, the UE 10 identifies that the access to cell2 is barred only if the content of the received DBI, matching with the configured DOM or combination of DOM and receiver configuration of the UE 10, is explicitly set to ‘barred’; otherwise if the DBI set is set to not barred then the UE 10 identifies that the access to cell2 is allowed (i.e. not barred).
   If the UE 10 identifies that the access to cell2 is barred, then the UE 10 does not access the cell. In this case in one example the UE 10 may access another cell or it may perform cell selection procedure. In another example the UE 10 may revert to the old serving cell (e.g. cell1) if the UE 10 was served by before or until the UE 10 has determined that the access to cell2 is barred.
   If the UE 10 identifies that the access to cell2 is not barred (e.g. the access is allowed) then the UE 10 may access the cell e.g. cell2. The one or more procedures related to accessing the cell may be performed by the UE 10 any time after receiving the DBI, e.g., immediately after receiving the DBI, at a future time, e.g., after pre-defined or configurable time period, when registration with the network is needed, when data arrives in the UE buffer etc. Examples of one or more procedures which may or can be performed by the UE with regards to the cell, e.g., cell2, when the access to that cell is allowed, i.e., not barred, are:
      Identifying or considering the cell, e.g., cell2, as the serving cell of the UE 10,
      performing one or more radio procedures for enabling the UE 10 to maintain synchronization with regards to cell2 e.g. time and/or frequency synchronization with regards to cell2,
      acquiring one or more additional SI elements, e.g., SIBs, of cell2,
      transmitting one or more uplink signals, e.g., RACH, in cell2,
      receiving or monitoring one or more downlink signals in cell2, e.g., control channel, data channel, paging etc.,
      performing one or more measurements on reference signals of cell2,
      registering with the network etc.
   In another example if the UE 10 identifies that the access to cell2 is barred then the UE 10 may reconfigure its currently configured DOM and/or its receiver configuration for enabling the UE 10 to access cell2. For example, a FD capable UE may not be allowed to access cell2 when configured with FD. But it is allowed to access cell2 when configured with other modes e.g. FDD, TDD, HD-FDD etc. The FD capable UE may further be capable of changing its DOM to any one or more of other DOMs. In one example, the UE 10 may reconfigure its DOM from FD to FDD and access cell2. The UE 10 may further inform the network, e.g., to cell1 or cell2, that it has changed its DOM, e.g., from FD to FDD in order to access cell2.

Examples of the second set of one or more tasks performed by the UE 10 based on the received CCI associated with certain DBI are related to whether the UE 10 can access another cell or not, are:
In one example, if the CCI indicates that the UE 10 can access another cell (different than cell2) then the UE 10 may perform cell selection or cell change to another cell. If the CCI also provides information about another cell, e.g., cell ID of cell3 or carrier frequency of other cells, then the UE 10 performs access to the other cell identified from the obtained CCI.
In another example, if the CCI indicates that the UE 10 cannot even access another cell (different than cell2) then the UE 10 may perform one or more of: abandons or discards the cell access procedure, postpones the cell access procedure for certain time period, e.g. 100 s, performs cell selection procedure, reverts to previous serving cell, e.g. cell1, if the UE 10 was served by it at least before or until the reception of CCI etc.

In another example, if the CCI indicates that the UE 10 cannot access any cell (different than cell2) operating on the carrier frequency, e.g. F2, of cell2, e.g. intra-frequency cell on F2, then the UE 10 may perform one or more of: does not perform access to any cell on F2, does not perform access to any cell on F2 for certain time period, e.g. 300 s, performs access to a cell on another carrier frequency, e.g. F3, different than F2, performs cell selection procedure, reverts to previous serving cell (e.g. cell1) if the UE 10 was served by it etc.

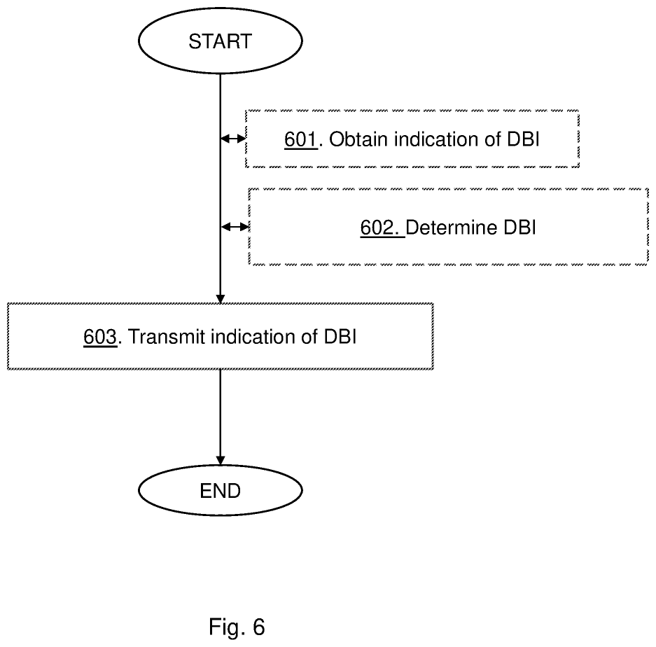

The method actions performed by a radio network node, such as the first radio network node 12 or the second radio network node 13, for handling communication in the wireless communications network according to embodiments will now be described with reference to a flowchart depicted in FIG. 6. The actions do not have to be taken in the order stated below but may be taken in any suitable order. Dashed boxes indicate optional features.
Action 601. The radio network node may obtain indication of the DBI, from another radio network node or internally, for a cell. The indication may be a real value, an index value or similar.
Action 602. The radio network node may determine the DBI and/or the CCI for the cell based on one or more criteria, such as capability and/or resources (available).
Action 603. The radio network node transmits the indication indicating DBI associated with or related to at least one DOM of the UE 10, wherein the DBI for a cell indicates whether the UE 10 supporting the at least one DOM can access the cell, or not. The DBI further comprises the CCI, wherein the CCI indicates that upon barring the cell whether the UE 10 can perform cell change to another cell, or not. The CCI may comprise information about one or more cells to which the UE 10 is to perform a cell change to. The indication may be transmitted to the UE 10 and/or the first radio network node 12. The indication may be a real value, an integer, text, or an index value.

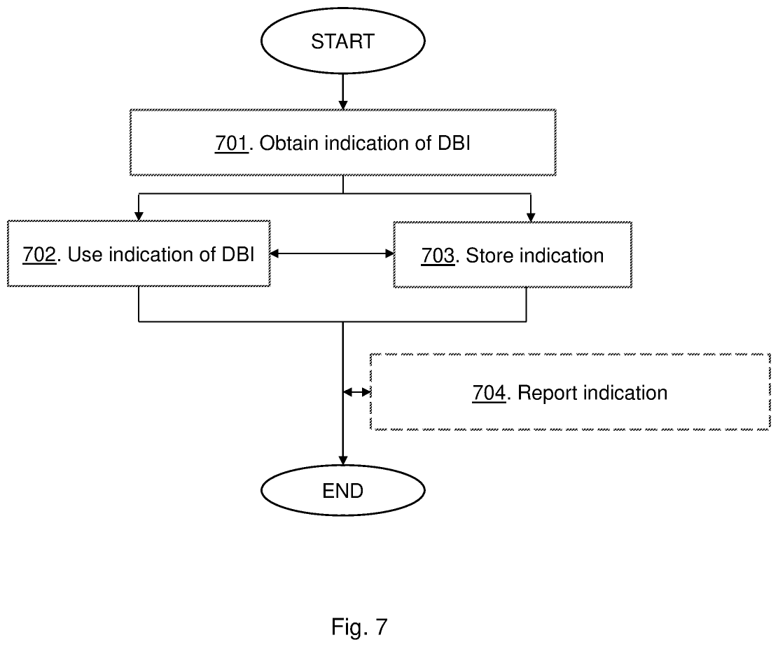

The method actions performed by the UE 10 for handling communication in the wireless communications network according to embodiments will now be described with reference to a flowchart depicted in FIG. 7. The actions do not have to be taken in the order stated below but may be taken in any suitable order. Dashed boxes indicate optional features.
Action 701. The UE 10 obtains the indication indicating the DBI associated with or related to at least one DOM of the UE 10, wherein the DBI for a cell indicates whether the UE supporting the at least one DOM can access the cell, or not. The DBI may further comprise the CCI, wherein the CCI indicates that upon barring the cell whether the UE 10 can perform cell change to another cell, or not. The CCI may comprise information about one or more cells to which the UE 10 is to perform a cell change to. The indication may be received from a radio network node or retrieved internally.
Action 702. The UE 10 uses the indication for determining whether the UE 10 can access a cell, such as a target or present cell, or not. The UE 10 may determine whether the UE 10 can access the cell or not based on whether the DBI is transmitted by the radio network node or not. Thus, the UE 10 may obtain the indication indicating the DBI by further determining whether the DBI for the cell is transmitted or not by a radio network node. For example, the UE 10 may determine that the UE 10 supporting the at least one DOM can access the cell if the DBI is transmitted by the radio network node or cannot access the cell if the DBI is not transmitted by the radio network node. The at least one DOM supported by the UE 10 may comprise at least one of: a half-duplex frequency division duplex and a full duplex.
Action 703. Alternatively, or additionally, the UE 10 stores the indication.
Action 704. The UE 10 may report the indication to a radio network node such as SON or MDT reporting.

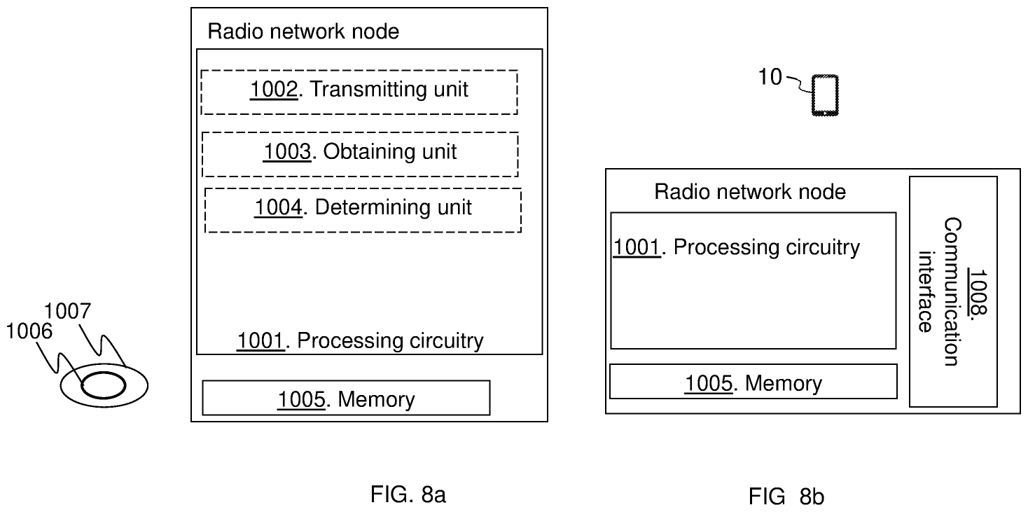

FIGS. 8a and 8b are block diagrams depicting the radio network node in two embodiments for handling communication in the wireless communications network 1 according to embodiments herein.

The radio network node may comprise processing circuitry 1001, e.g., one or more processors, configured to perform the methods herein.

The radio network node may comprise a transmitting unit 1002, e.g., a transmitter or a transceiver. The radio network node, the processing circuitry 1001 and/or the transmitting unit 1002 is configured to transmit the indication indicating DBI associated with or related to at least one DOM of the UE 10, wherein the DBI for a cell indicates whether the UE 10 supporting the at least one DOM can access the cell, or not. The DBI further comprises the CCI, wherein the CCI indicates that upon barring the cell whether the UE can perform cell change to another cell, or not. The CCI may comprise information about one or more cells to which the UE 10 is to perform a cell change to. The indication may be transmitted to the UE 10 and/or the first radio network node 12.

The radio network node may comprise an obtaining unit 1003, e.g., a receiver and/or a transceiver. The radio network node, the processing circuitry 1001 and/or the obtaining unit 1003 may be configured to obtain the indication of the DBI, from another radio network node or internally, for a cell.

The radio network node may comprise a determining unit 1004. The radio network node, the processing circuitry 1001 and/or the determining unit 1004 may be configured to determine the DBI and/or the CCI for the cell based on one or more criteria, such as capability and/or resources.

The radio network node may comprise a memory 1005. The memory 1005 comprises one or more units to be used to store data on, such as data packets, DBIs, CCIs, RA configurations, allocated resources, thresholds, events and applications to perform the methods disclosed herein when being executed, and similar. Furthermore, the radio network node may comprise a communication interface 1008 such as comprising a transmitter, a receiver, a transceiver and/or one or more antennas.

The methods according to the embodiments described herein for the radio network node are respectively implemented by means of e.g. a computer program product 1006 or a computer program, comprising instructions, i.e., software code portions, which, when executed on at least one processor, cause the at least one processor to carry out the actions described herein, as performed by the radio network node. The computer program product 1006 may be stored on a computer-readable storage medium 1007, e.g. a disc, a universal serial bus (USB) stick or similar. The computer-readable storage medium 1007, having stored thereon the computer program product, may comprise the instructions which, when executed on at least one processor, cause the at least one processor to carry out the actions described herein, as performed by the radio network node. In some embodiments, the computer-readable storage medium may be a transitory or a non-transitory computer-readable storage medium. Thus, embodiments herein may disclose a radio network node for handling communication in a wireless communications network, wherein the radio network node comprises processing circuitry and a memory, said memory comprising instructions executable by said processing circuitry whereby said radio network node is operative to perform any of the methods herein.

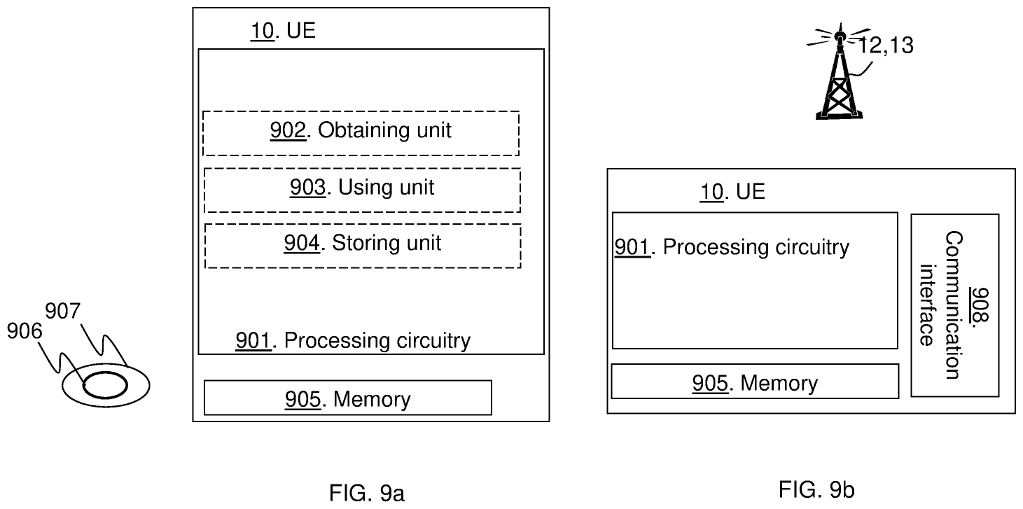

FIGS. 9a and 9b are block diagrams depicting the UE 10 in two embodiments for handling communication in the wireless communications network 1 according to embodiments herein.

The UE 10 may comprise processing circuitry 901, e.g., one or more processors, configured to perform the methods herein.

The UE 10 may comprise an obtaining unit 902, e.g., a receiver or transceiver. The UE 10, the processing circuitry 901 and/or the obtaining unit 902 is configured to obtain the indication indicating the DBI associated with or related to at least one DOM, of the UE 10, wherein the DBI for a cell indicates whether the UE 10 supporting the at least one DOM can access the cell, or not. The DBI may further comprise the CCI, wherein the CCI indicates that upon barring the cell whether the UE 10 can perform cell change to another cell, or not. The CCI may comprise information about one or more cells to which the UE is to perform a cell change to. The indication may be received from a radio network node or retrieved internally. The at least one DOM supported by the UE 10 may comprise at least one of: a half-duplex frequency division duplex and a full duplex.

The UE 10 may comprise a using unit 903. The UE 10, the processing circuitry 901 and/or the using unit 903 may be configured to use the indication for determining whether the UE 10 can access the cell or not. The UE 10 may be configured to determine whether the UE 10 can access the cell or not based on whether the DBI is transmitted by a radio network node or not.

The UE 10 may comprise a storing unit 904. The UE 10, the processing circuitry 901 and/or the storing unit 904 may be configured to store the indication.

The UE 10 may comprise a memory 905. The memory 905 comprises one or more units to be used to store data on, such as data packets, DBI, DOM, indications, thresholds, signal strengths/qualities, measurements, RA procedures, events and applications to perform the methods disclosed herein when being executed, and similar. Furthermore, the UE 10 may comprise a communication interface 908 such as comprising a transmitter, a receiver, a transceiver and/or one or more antennas.

The methods according to the embodiments described herein for the UE 10 are respectively implemented by means of e.g. a computer program product 906 or a computer program, comprising instructions, i.e., software code portions, which, when executed on at least one processor, cause the at least one processor to carry out the actions described herein, as performed by the UE 10. The computer program product 906 may be stored on a computer-readable storage medium 907, e.g. a disc, a universal serial bus (USB) stick or similar. The computer-readable storage medium 907, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium. Thus, embodiments herein may disclose a UE 10 for handling communication in a wireless communications network, wherein the UE 10 comprises processing circuitry and a memory, said memory comprising instructions executable by said processing circuitry whereby said UE 10 is operative to perform any of the methods herein.

In some embodiments a more general term “radio network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, gNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

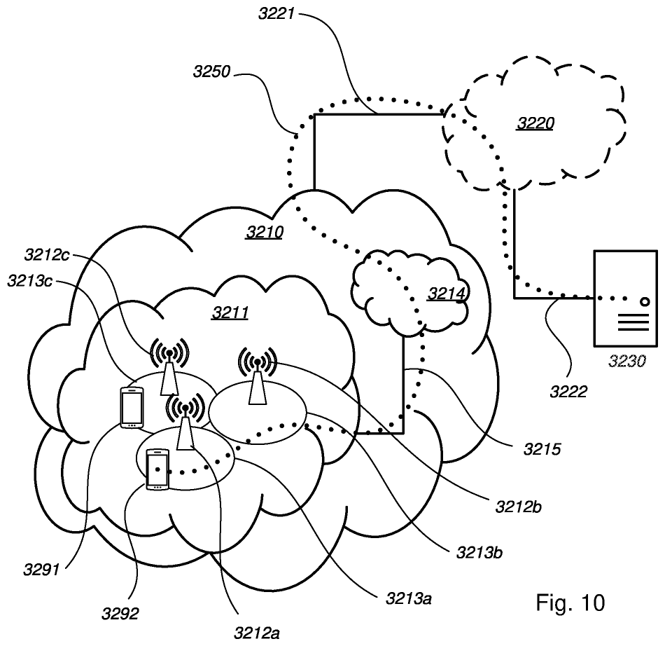

With reference to FIG. 10, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 10 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signalling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

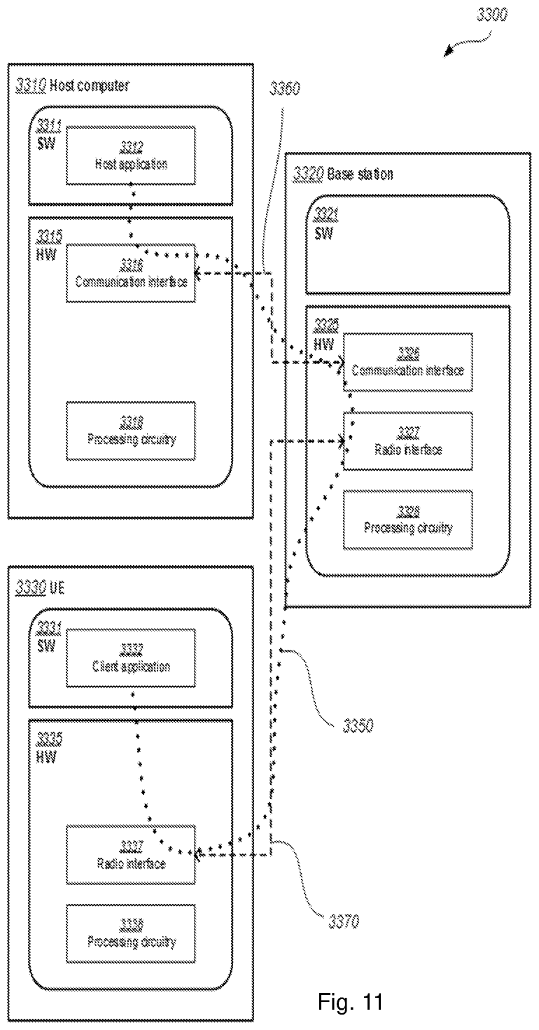

Example implementations, in accordance with an embodiment, of the UE, base station and host computer discussed in the preceding paragraphs will now be described with reference to FIG. 11. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 11) served by the base station 3320. The communication interface 3326 may be configured to facilitate a connection 3360 to the host computer 3310. The connection 3360 may be direct or it may pass through a core network (not shown in FIG. 11) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 11 may be identical to the host computer 3230, one of the base stations 3212a, 3212b, 3212c and one of the UEs 3291, 3292 of FIG. 10, respectively. This is to say, the inner workings of these entities may be as shown in FIG. 11 and independently, the surrounding network topology may be that of FIG. 10.

In FIG. 11, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing, e.g., on the basis of load balancing consideration or reconfiguration of the network.

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since UEs will avoid accessing cells for DOMs not supported by the UE and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

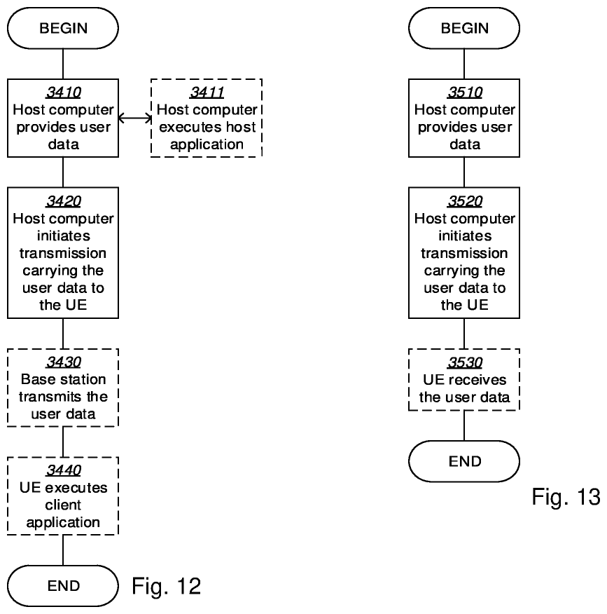

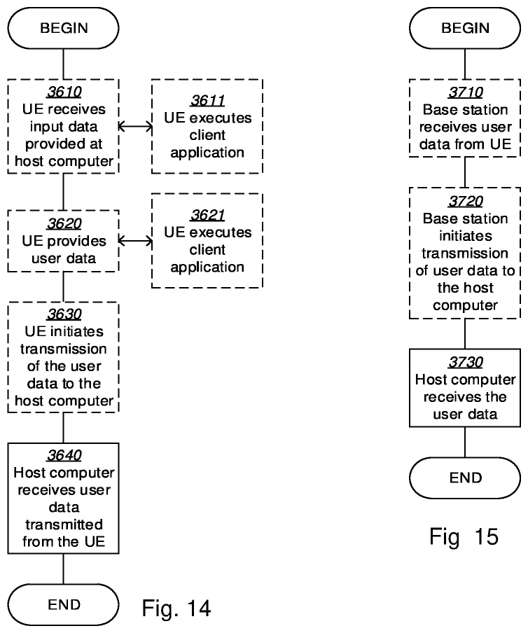

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

| Abbreviation | Explanation |
|---|---|
| ACK | Acknowledgement |
| AR | Augmented reality |
| BLER | Block error rate |
| BWP | Bandwidth part |
| CCI | Cell change information |
| CP | Cyclic prefix |
| CSI-RS | Channel state information reference signals |
| CSSF | Carrier-specific scaling factor |
| DCI | Downlink control information |
| DBI | Duplex barring information |
| DL | Downlink |
| DOM | Duplex operational mode |
| eMBB | Evolved mobile broadband |
| FDD | Frequency division duplex |
| FR1 | Frequency range 1 |
| FR2 | Frequency range 2 |
| FR3 | Frequency range 3 |
| gNB | Next generation Node B (5G base station) |
| HARQ | Hybrid automatic repeat request |
| IMS | IP Multimedia Subsystem |
| MAC | Medium access control |
| NR | New radio (5G) |
| PBCH | Physical broadcast channel |
| PDCCH | Physical downlink control channel |
| PDSCH | Physical downlink shared channel |
| PRS | Positioning reference signals |
| PUCCH | Physical uplink control channel |
| PUSCH | Physical uplink shared channel |
| RAT | Radio access technology |
| RRC | Radio resource control |
| RRM | Radio resource management |
| SCS | Subcarrier spacing |
| SFN | System frame number |
| SMTC | SSB measurement timing configuration |
| SRS | Sounding reference signal |
| SSB | Synchronization signal and PBCH block |
| TDD | Time division duplex |
| UL | Uplink |

1-24. (canceled)

25. A method performed by a radio network node for handling communication in a wireless communications network, the method comprising:
transmitting an indication indicating duplex barring information (DBI) associated with or related to at least one duplex operational mode (DOM) of a user equipment (UE), wherein the DBI for a cell indicates whether the UE supporting the at least one DOM can access the cell.

26. The method of claim 25, wherein the DBI further comprises cell change information (CCI), wherein the CCI indicates that upon barring the cell whether the UE can perform cell change to another cell.

27. The method of claim 26, wherein the CCI further comprises information about one or more cells to which the UE is to perform a cell change to.

28. The method of claim 25, wherein the indication is transmitted to the UE and/or a first radio network node.

29. The method of claim 25, further comprising determining the DBI and/or CCI for the cell based on one or more criteria.

30. A method performed by a user equipment (UE) for handling communication in a wireless communications network, the method comprising:
obtaining an indication indicating duplex barring information (DBI) associated with or related to at least one duplex operational mode (DOM) of the UE, wherein the DBI for a cell indicates whether the UE supporting the at least one DOM can access the cell;
using the indication for determining whether the UE can access a cell and/or storing the indication.

31. The method of claim 30, wherein determining whether the UE can access the cell is based on whether the DBI is transmitted by a radio network node.

32. The method of claim 30, wherein the DBI further comprises cell change information (CCI), wherein the CCI indicates that upon barring the cell whether the UE can perform cell change to another cell.

33. The method of claim 32, wherein the CCI further comprises information about one or more cells to which the UE is to perform a cell change to.

34. The method of claim 30, wherein the indication is received from a radio network node or retrieved internally.

35. The method of claim 30, wherein the at least one DOM supported by the UE comprises at least one of: a half-duplex frequency division duplex and a full duplex.

36. A radio network node for handling communication in a wireless communications network, wherein the radio network node is configured to:
transmit an indication indicating duplex barring information (DBI) associated with or related to at least one duplex operational mode (DOM) of a user equipment (UE), wherein the DBI for a cell indicates whether the UE supporting the at least one DOM can access the cell.

37. The radio network node of claim 36, wherein the DBI further comprises cell change information (CCI), wherein the CCI indicates that upon barring the cell whether the UE can perform cell change to another cell.

38. The radio network node of claim 37, wherein the CCI comprises information about one or more cells to which the UE is to perform a cell change to.

39. The radio network node of claim 36, wherein the indication is transmitted to the UE and/or a first radio network node.

40. The radio network node of claim 36, wherein the radio network node is further configured to
determine the DBI and/or CCI for the cell based on one or more criteria.

41. A user equipment (UE) for handling communication in a wireless communications network, wherein the UE is configured to:
obtain an indication indicating duplex barring information (DBI) associated with or related to at least one duplex operational mode (DOM) of the UE, wherein the DBI for a cell indicates whether the UE supporting the at least one DOM can access the cell; and
use the indication for determining whether the UE can access a cell and/or store the indication.

42. The UE of claim 41, wherein the UE is configured to determine whether the UE can access the cell based on whether the DBI is transmitted by a radio network node.

43. The UE of claim 41, wherein the DBI further comprises cell change information (CCI), wherein the CCI indicates that upon barring the cell whether the UE can perform cell change to another cell.

44. The UE of claim 43, wherein the CCI comprises information about one or more cells to which the UE is to perform a cell change to.

45. The UE of claim 41, wherein the indication is received from a radio network node or retrieved internally.

46. The UE of claim 41, wherein the at least one DOM supported by the UE comprises at least one of: a half-duplex frequency division duplex and a full duplex.
